(19) United States
(12) Patent Application Publication
(10) Pub. No.: US 2009/0070722 A1
(43) Pub. Date: Mar. 12, 2009

(54) METHOD FOR GENERATING DEVICE MODEL OVERRIDES THROUGH THE USE OF ON-CHIP PARAMETRIC MEASUREMENT MACROS

(76) Inventors: Jeanne Bickford, Essex Junction, VT (US); John R. Gross, South Burlington, VT (US); Nazmul Habib, South Burlington, VT (US); Robert McMahon, Essex Junction, VT (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/851,073

(22) Filed: Sep. 6, 2007

(51) Int. Cl. G06F 17/50

(52) U.S. Cl. 716/10

(57) ABSTRACT

A method generates area dependent design rules during semiconductor technology qualification by identifying the layout parametric variation in a semiconductor technology and establishing layout dependent design rules. This method applies the area dependent design rules to identify design sensitivity to area dependent design rules and to optimize semiconductor libraries and/or semiconductor products using an on-chip parametric monitor by designing processes for library elements, semiconductor design systems, and/or custom semiconductor products using the layout dependent design rules.

### BACKGROUND AND SUMMARY

The embodiments of the invention generally relate to novel application of on chip parametric monitoring.

Current semiconductor chip technology qualification and measurement methods rely on scribe line measurements and limited manual characterization of parametric structures. However, with conventional methods, the sample size is limited and the time needed for data collection is long.

One problem with conventional systems is that it is difficult to measure/characterize the scribe line to on chip offset. Further, with conventional methods, different density environments on chip are not characterized and variation is known to be different in different layout environments. Further, design rules are not developed that allow designers to optimize a product for density variations. Variations in a manufactured product will be less if layout sensitivity to variation is planned in design. Also, current design rules are not layout specific and no credit is given for design practices which result in tighter distributions. Layout sensitivities are currently identified during production ramp up. However, layouts are very difficult and expensive to correct at this late stage, which results in significant systematic yield loss results.

One method that can be used with the invention is known as “Godata/Device Model Overrides.” Godata/Device Model Overrides provide circuit designers with the ability to produce a model which matches the properties of the actual hardware being characterized. Such a method conventionally relies on scribe line measurements, and is dependent on only one measurement per reticle for all the chips in the reticle. Different density environments on the chip are not characterized. In-line test time significantly increased in order to get the desired 100% in-line test (all sites on all wafers) for each lot. Physical placement and the distance between kerf structures and test chips within the reticle results in kerf to chip offset that must be accounted for. Two separate test data flows result in two different databases for in-line test and wafer final test. In-line test data collection time is separate for each test pass and is not insignificant. There is always an inherent scribe-to-chip offset in the current methodology because the kerf is at a distance from the chips. This is already a cause of concern for closing model to hardware correlation (MHC) and requires in-line test data and wafer final test data for the same functionally good chips to accomplish meaningful MHC and product qualification.

In view of the foregoing, embodiments herein, provide an improved method of generating and applying area dependent design rules. More specifically, the method disclosed herein generates area dependent design rules during semiconductor technology qualification by identifying the layout parametric variation in a semiconductor technology and establishing layout dependent design rules. This method applies the area dependent design rules to identify design sensitivity to area dependent design rules and to optimize semiconductor libraries and/or semiconductor products using an on-chip parametric monitor by designing processes for library elements, semiconductor design systems, and/or custom semiconductor products using the layout dependent design rules.

The process of identifying the layout parametric variation in a semiconductor technology and establishing layout dependent design rules includes on-chip parametric measurement structures in a semiconductor test site and in scribe line measurement macros and places the on-chip parametric measurement structure in a variety of different design environments. The designing of the processes for the library elements, semiconductor design systems, and custom semiconductor products can include on-chip parametric measurement macros, in a semiconductor test site and in scribe line measurement macros. The scaling parametric measurement macro (SPM) is an example of an on-chip parametric measurement macro. Further, this process can place on-chip parametric measurement macros in a variety of different design environments and collect data using one or more on-chip parametric measurement macros in addition to scribe line measurement structure at a collection of voltages and temperatures that cover a planned product specification. This method identifies parametric variation in the different design environments and correlates the parametric variation to the layout environment over a planned product specification range. Thus, this modifies the circuit functionality expectation based on layout by applying different device model expectations.

In other words, the method places parametric monitors in different design environments, builds hardware within parametric limits, collects parametric data while building the hardware using the parametric monitors, and correlates the parametric data to each different design layout environment. When building the hardware, the method creates a technology design manual with density dependent parametric rules, and designs the hardware using the parametric limits. The method places the parametric monitors in semiconductor wafer kerf regions and within semiconductor chips.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a parametric testing device;

FIG. 2 is a flow diagram illustrating a method embodiment of the invention; and

FIG. 3 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

This invention address the problems outlined above through use of a novel application of on chip parametric monitoring. This technique provides a means to more quickly qualify a semiconductor technology and to develop design rules that allow development of more competitive products through use of density dependent design rules using chip parametric measurements. This method can use any integrated circuit that allows device level parametric measurements in a manufacturing test environment to determine parametric values at wafer test, or module test.

Features of the invention include a scalable parametric measurement macro or similar parametric macro, in semiconductor test site and “in the scribe line” measurement macros that are located in the kerf or scribe line regions of the wafer. The invention can place parametric macros in a variety of different design environments (different density, big isolated shaped, adjacent to SRAMs, etc). This technique provides a means to more quickly qualify a semiconductor technology and to develop design rules that allow development of more competitive products through the use of density dependent design rules using chip parametric measurements.

As mentioned above, the invention provides an improved method of generating and applying area dependent design rules. More specifically, the method disclosed herein generates area dependent design rules during semiconductor technology qualification by identifying the layout parametric variation in a semiconductor technology and establishing layout dependent design rules. This method applies the area dependent design rules to identify design sensitivity to area dependent design rules and to optimize semiconductor libraries and/or semiconductor products using an on-chip parametric monitor by designing processes for library elements, semiconductor design systems, and/or custom semiconductor products using the layout dependent design rules.

Further, the process of identifying the layout parametric variation in a semiconductor technology and establishing layout dependent design rules includes on chip parametric measurement structures in a semiconductor test site and in scribe line measurement macros and places the on chip parametric measurement structure in a variety of different design environments. The designing of the processes for the library elements, semiconductor design systems, and custom semiconductor products can include on-chip parametric measurement macros, in a semiconductor test site and in scribe line measurement macros. Further, this process can place the on-chip parametric measurement macros in a variety of different design environments and collect data using one or more on-chip parametric measurement macros, in addition to scribe line kerf at a collection of voltages and temperatures that cover a planned product specification. This method identifies parametric variation in the different design environments and correlates the parametric variation to the layout environment over a planned product specification range. Thus, this modifies the circuit functionality expectation based on layout by applying different device model expectations.

The present invention provides a means to improve the generation of the Godata/Device Model Overrides by using on-chip parametric measurements to take more accurate parametric measurements and reduce dependency on the scribe line measurements. This will make closure of model to hardware correlation for technology qualification more efficient. This method can use any integrated circuit that allows device level parametric measurements in a manufacturing test environment to determine parametric values and thus generate the key Godata/device model overrides at wafer or module test.

Elements of embodiments herein include Scalable Parametric Measurement Macro, or similar parametric macro, in semiconductor test site and in the scribe line measurement macros. The invention can place parametric macros in a variety of different design environments, e.g., different densities, large isolated shapes etc. The invention can collect data using one or more on-chip parametric macros in addition to scribe line kerf. The invention has flexibility to customize DUTs/macros to further improve available parametric data for MHC activities which is not solely dependent on scribe line structures (which mostly consist of structures not used in the chip).

Godata and Device Model Overrides are a set of values fed into semiconductor device models to override the default values for the desired parameters contained in the model. A few examples of some typical parameters overridden in the device models are Lpoly, Vth, Toxinv, Cov, Cj, and Rs. The use of Godata/Device Model Overrides allows specific parameters to be overridden independently of other parameters. This enables sensitivity analysis with respect to any desired parameter as well as the modeling of devices with specific characteristics.

Godata/Device Model Overrides provide circuit designers with the ability to produce a model which matches the properties of the actual hardware being characterized. The Godata/Device Model Overrides for each reticle within a wafer are then used to simulate different logic circuits on that reticle chip by overriding key device parameters in the default device models. Results of the simulation (using the Godata/Device Model Overrides) of the circuits within each chip in the wafer reticle are then compared with hardware measurements for that reticle.

As mentioned above, a current method of generating “Godata/Device Model Overrides” for technology qualification relies on scribe line measurements. Such a method is dependent on only one measurement per reticle for all the chips in the reticle. Different density environments on chip are not conventionally characterized. Variation is known to be different in different layout environments. In-line test time significantly is increased in order to get the desired 100% in-line test (all sites on all wafers) for each lot. Physical placement and the distance between kerf structures and test chips within the reticle results in kerf to chip offset that must be accounted for. Two separate test data flows results in two different databases for in-line test and wafer final test. There is always an inherent scribe-to-chip offset in the current methodology because the kerf is at a distance from the chips. This is already a cause of concern for closing the model to hardware correlation (MHC) and requires in-line test data and wafer final test data for the same functionally good chips to accomplish meaningful MHC and product qualification.

This technique disclosed herein provides a means to improve the generation of the Godata/Device Model Overrides by using on-chip parametric measurements to take more accurate parametric measurements and reduce dependency on the scribe line measurements. This makes closure of model to hardware correlation for technology qualification more efficient.

This method can use any integrated circuit that allows device level parametric measurements in a manufacturing test environment to determine parametric values and thus generate the key Godata/device model overrides at wafer or module test.

The invention has reduced offset between scribe line and chip for device and process characteristics. The invention has resulting godata/overrides which are more meaningful than those based on scribe structures. The invention has use of the same test results database for correlation activities to improve data manipulation logistics. Parametric measurements from close proximity to the IP being characterized are in the invention. The invention has improved parametric data collection time by incorporating into existing automated wafer test.

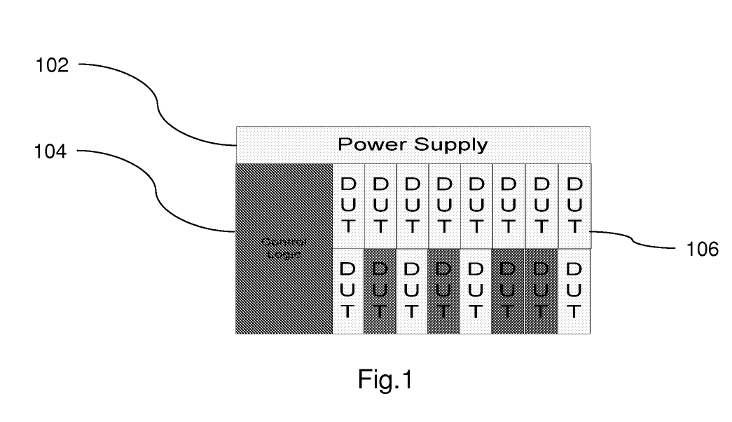

One example of testing hardware used with embodiments herein is shown in FIG. 1, and includes a power supply 102 and control logic 104 used to test devices under test (DUTs) 106. The on-chip parametric measurement macros is an on-chip parametric performance monitoring system. It is included on all product chips 106, is tested at wafer final test (WFT), and its placement requires no on-chip parametric measurement macros-specific, external pinout. Collected data may be used to disposition product, provide feedback to the manufacturing line, and establish a historical database of key parameters monitored at the fab and/or product level. Some examples of data collected using this macro include ION, VTH, BEOL, and can be readily expanded upon through the processes described in this disclosure.

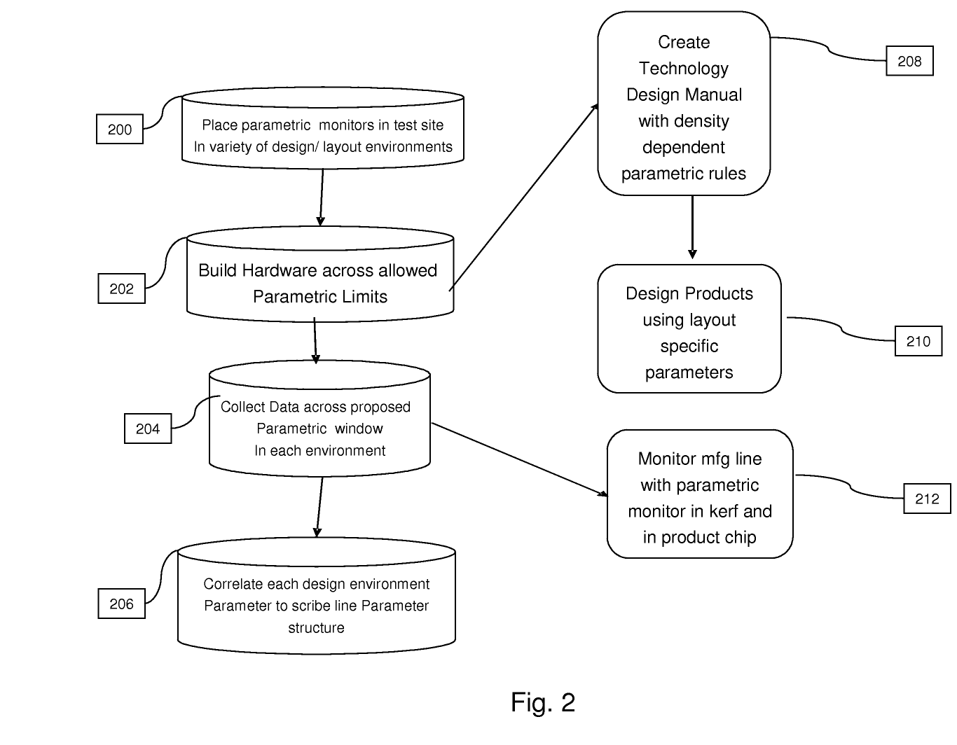

As shown in flowchart form in FIG. 2, the method places parametric monitors in the test site of a variety of different design and layout environments (item 200). In item 202, the method builds hardware within parametric limits. In item 204, the method collects parametric data across the proposed parametric window in each environment while building the hardware (using the parametric monitors). In item 206, the method correlates the parametric data to each different design layout environment by correlating each design environment parameter to an associated scribe line parameter structure.

When building the hardware in item 202, the method creates a technology design manual with density dependent parametric rules (208), and designs the hardware using the parametric limits (210). The method places the parametric monitors in semiconductor wafer kerf regions and within semiconductor chips and therefore monitors the manufacturing line using the parametric monitors that are in the kerf regions and that are in the chips being produced.

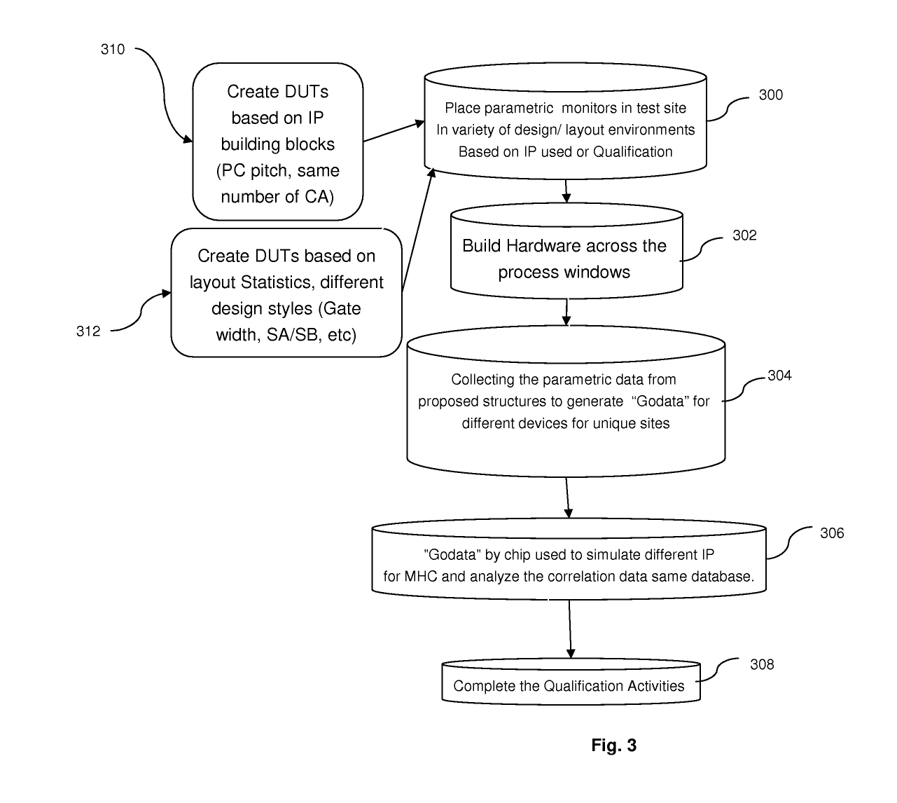

As shown in flowchart form in FIG. 3, the method places parametric monitors in the test site of a variety of different design and layout environments (item 300). Item 300 uses two items which work together. In item 310, the method creates DUTs based on IP building blocks (PC pitch, same number of CA) and in item 312, the method creates DUTs based on layout statistics, different design styles (Gate width, SA/SB, etc.). In item 302, the method builds hardware across the process windows. In item 304, the method collects parametric data from the proposed structures to generate “Godata” for different devices for unique sites. In item 306, “Godata” by chip is used to simulate different IP for MHC and analyze the correlation data same database. In item 308, the method completes the qualification activities.

The invention reduces resource requirements for generating the device model overrides. Turn around time will be improved. The invention provides more accurate overrides than the scribe line data. The invention provides flexibility to design the DUTs based on the devices used on the IP construction. The invention provides the flexibility to create IP environment (PC density, RX density, etc). The invention also provides the flexibility to create the same layout pattern as the IP (same PC pitch, same number of CA, etc). The invention provides more confidence to use the device adders than on the scribe line. In the invention, there is no need to account for Chip-Scribe line offset. In the invention, there is usage of the same database, so the conversion or merging the data is easier. Less dependence on the scribe line data and request process can be ignored. MHC activities can be performed at both wafer level and module level (to see if the device characteristics change from wafer to module).

This method can use any integrated circuit that allows device level parametric measurements in a manufacturing test environment to determine parametric values at in wafer test, or module test. The invention can place parametric macros in variety of different design environments (different density, big isolated shaped, adjacent to SRAMs, etc). The parametric macro can be tested using automated wafer test—fast test. The invention can collect data using the parametric macro. The invention can specify a parameter value based on layout environment design rules for use by designers. The invention can monitor representative layout environments in manufacturing using the on chip parametric macro to ensure compliance with parametric layout design rules.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method comprising:
placing parametric monitors in different design environments;
building hardware within parametric limits;
collecting parametric data while building said hardware using said parametric monitors; and
correlating said parametric data to each different design environment.

2. The method of claim 1, wherein said building of said hardware comprises:
creating a technology design manual with density dependent parametric rules; and
designing said hardware using said parametric limits.

3. The method of claim 1, wherein said placing of said parametric monitors comprises placing said parametric monitors in semiconductor wafer kerf regions and within semiconductor chips.

4. A method comprising:
generating area dependent design rules during semiconductor technology qualification by identifying a layout parametric variation in a semiconductor technology and establishing layout dependent design rules; and
applying said area dependent design rules to identify design sensitivity to area dependent design rules and to optimize semiconductor libraries and semiconductor products using an on-chip parametric monitor by designing processes for at least one of library elements, semiconductor design systems, and custom semiconductor products using said layout dependent design rules.

5. The method of claim 4, wherein said identifying of said layout parametric variation in a semiconductor technology and establishing layout dependent design rules comprises:
including on chip parametric measurement structures in a semiconductor test site and in scribe line measurement macros; and
placing said on chip parametric measurement structure in a variety of different design environments.

6. The method of claim 4, wherein said designing of said processes for at least one of library elements, semiconductor design systems, and custom semiconductor products using said layout dependent design rules comprises:
including on-chip parametric measurement macros in a semiconductor test site and in scribe line measurement macros;
placing said on-chip parametric measurement macros in a variety of different design environments;
collecting data using one or more on-chip parametric measurement macros in addition to scribe line measurement structure at a collection of voltages and temperatures that cover a planned product specification;
identifying parametric variation in said different design environments;
correlating parametric variation to layout environment over a planned product specification range; and
modifying circuit functionality expectation based on layout by applying different device model expectations.
